(19) United States
(12) Patent Application Publication
(10) Pub. No.: US 2026/0003576 A1
(43) Pub. Date: Jan. 1, 2026

(54) Near-Memory Random and Pattern-Based Number Generation

(71) Applicant: Advanced Micro Devices, Inc., Santa Clara, CA (US)

(72) Inventors: William Peter Ehrett, Austin, TX (US); Nuwan S. Jayasena, Cupertino, CA (US); Yasuko Eckert, Redmond, WA (US); Gabriel Hsiuwei Loh, Bellevue, WA (US)

(73) Assignee: Advanced Micro Devices, Inc., Santa Clara, CA (US)

(21) Appl. No.: 18/755,465

(22) Filed: Jun. 26, 2024

(51) Int. Cl. G06F 7/58

(52) U.S. Cl. CPC G06F 7/582

(57) ABSTRACT

In aspects of near-memory random and pattern-based data generation, a system includes a number generator circuit configured to generate a sequence of numbers, a memory chip configured to store the sequence of numbers, and a memory interface configured to enable communication between the number generator circuit and the memory chip. In one or more implementations, the number generator circuit includes a random number generator circuit configured to generate the sequence of numbers as a sequence of random numbers. Additionally, or alternatively, the number generator circuit includes a pattern fill function configured to generate the sequence of numbers based on a pattern. In other aspects of near-memory random and pattern-based data generation, a memory device includes a base layer, a memory interface, and a number generator circuit interleaved among the base layer and the memory interface.

### BACKGROUND

Bulk memory initialization operations, such as memset and random number generation, are used in various data analytics, machine learning, and high-performance computing applications. These operations involve setting a block of memory to a specific value, e.g., as in memset, or filling the block with random numbers. In data analytics and machine learning, memory initialization is often a preliminary step to prepare data structures like arrays or matrices before processing or learning begins. The step of generating random numbers is vital for ensuring data integrity and consistency throughout the computational process.

### BRIEF DESCRIPTION OF THE DRAWINGS

FIG. 1 depicts a non-limiting example system having a host including one or more cores, and a memory including a number generator circuit, a memory interface, and one or more memory chips.

FIG. 2 depicts a non-limiting example configuration of a number generator circuit having an input interface, true random number generator circuit, a pseudo random number generator circuit, a pattern fill circuit, multiple arithmetic logic units, and multiple output interfaces.

FIG. 3 depicts multiple views of a non-limiting example memory device having a base layer, a memory interface, and a number generator circuit interleaved among the base layer and the memory interface.

FIG. 4 depicts example implementations of a non-limiting example memory device configured to supply random numbers to an arithmetic logic unit for stochastic applications.

FIG. 5 depicts a method for generating a sequence of random numbers via a random number generator circuit integrated within a memory device.

FIG. 6 is a block diagram of a processing system configured to execute one or more applications, in accordance with one or more implementations.

### DETAILED DESCRIPTION

### Overview

Random number generation is a fundamental tool in computing, including in high-performance computing and machine learning. In high-performance computing, the need for high-quality random numbers is essential for various applications, such as Monte Carlo-based simulations in radiation transport and lattice quantum chromodynamics. These simulations consume a significant portion of resources in national supercomputing facilities. As the scale of problems grows, random number generators should be more statistically robust to prevent anomalies and issues in environments with an increasing number of parallel processors. Consequently, pseudo-random number generators are becoming more complex and demanding to meet both the quality and throughput requirements of massively parallel systems. Moreover, as computing scales to exascale (i.e., 10¹⁸ floating-point operations per second) and beyond, the computational load dedicated to pseudo-random number generators also grows. True-random number generators do not require features necessary for pseudo-random number generators applied to large-scale problems. However, many applications benefit from reproducibility, necessitating the use of pseudo-random number generators with known seeds or the storage of true-random number streams. Deterministic jump ahead is one such feature that allows for the calculation of a future state in a pseudo-random number sequence without generating all intermediate states, ensuring efficient and non-overlapping random number generation for parallel processes.

In machine learning, random number generators are integral to various techniques, including stochastic rounding for improved results with low-precision data types. Random number generators are also useful for transformers in large language models, where different phases or parallelization strategies use varied random number generator patterns. Sometimes parallel workers use identical pseudo-random number generators seeds, and other times, parallel workers use different random patterns. Therefore, a random number generator solution should be versatile enough to cater to diverse requirements across different applications and workload phases.

Random number generators, encompassing both true and pseudo-random types, are widely utilized in modern computing. For instance, some chip manufacturers have integrated random number generator hardware into its commodity devices. Additionally, innovative random number generator designs have been suggested, such as those utilizing dynamic random-access memory itself as a source of entropy. Meanwhile, the concept of accelerating memset operations has been previously explored, although past proposals mainly focus on utilizing co-processors. This differs from the approach of the techniques described herein, which emphasize a unit located near the memory for more efficient operation. Furthermore, the idea of accelerating stochastic rounding has been proposed. However, these solutions still depend on an external source for random numbers.

Near-memory random and pattern-based number generation is described. In one or more implementations, a system includes a number generator circuit, a memory interface, and a memory chip. The number generator circuit is configured to generate a sequence of numbers using true random number generation and/or pseudo random number generation. The number generator circuit additionally or alternatively generates the sequence of numbers via an implementation of a memset or similar function to set a block of memory to a specific value to initialize or reset a memory area. The number generator circuit is tightly integrated with the memory interface, such as part of a three-dimensional stacked package for improved performance and power efficiency, to enable communication with the memory chip for read/write operations.

The use of dedicated hardware and parallel processing as discussed herein significantly enhances performance, improving wall-clock-time (i.e., actual elapsed time) efficiency by allowing compute dies to focus on other tasks. This approach also enhances the quality of random numbers, particularly in designs employing true random number generators. Additionally, the dedicated hardware contributes to increased power efficiency, achieved through reduced communication with the compute die, whether in 2.5D or 3D formats. This power efficiency leads to better thermal management, due to the reduced data movement and the inherent efficiency of the dedicated hardware. The composability aspect of this design is also notable. In some implementations, for instance, by situating the hardware in a 3D-dynamic random access memory (DRAM) base die, the described techniques allow for various stack configurations, catering to different target use cases with different random number generators, or including the functionality in a subset of memory stacks. This flexibility can reduce cost and complexity in more dataflow-oriented configurations, such as scenarios where one stack acts as a data producer for other downstream stacks.

In some aspects, the techniques described herein relate to a system including: a number generator circuit configured to generate a sequence of numbers, a memory chip configured to store the sequence of numbers, and a memory interface configured to enable communication between the number generator circuit and the memory chip.

In some aspects, the techniques described herein relate to a system, further including a system-on-chip, and wherein the system-on-chip includes one or more processor cores, the number generator circuit, the memory chip, and the memory interface.

In some aspects, the techniques described herein relate to a system, wherein the number generator circuit includes a random number generator circuit.

In some aspects, the techniques described herein relate to a system, further including an arithmetic logic unit (ALU) configured to receive an operand from the random number generator circuit and to output the sequence of numbers.

In some aspects, the techniques described herein relate to a system, wherein the random number generator circuit includes a true random number generator circuit, a pseudo random number generator circuit, or both the true random number generator circuit and the pseudo random number generator circuit.

In some aspects, the techniques described herein relate to a system, wherein the true random number generator circuit is configured to output a seed, and the pseudo random number generator circuit is configured to receive the seed as input.

In some aspects, the techniques described herein relate to a system, wherein the pseudo random number generator circuit is a deterministic random bit generator circuit.

In some aspects, the techniques described herein relate to a system, wherein the number generator circuit implements, at least in part, a pattern fill function, and further including an arithmetic logic unit configured to receive an operand from the pattern fill function.

In some aspects, the techniques described herein relate to a system, further including a three-dimensional package including a base layer, the base layer including the memory interface and the number generator circuit.

In some aspects, the techniques described herein relate to a memory device including: a base layer, a memory interface, and a number generator circuit interleaved among the base layer and the memory interface and configured to generate a sequence of numbers.

In some aspects, the techniques described herein relate to a memory device, further including one or more memory layers connected to the number generator circuit via the memory interface.

In some aspects, the techniques described herein relate to a memory device, wherein the one or more memory layers are built directly on top of the base layer.

In some aspects, the techniques described herein relate to a memory device, wherein the one or more memory layers are stacked vertically.

In some aspects, the techniques described herein relate to a memory device, wherein the number generator circuit includes a pseudo random number generator circuit configured to generate the sequence of numbers based, at least in part, on a seed.

In some aspects, the techniques described herein relate to a memory device, wherein the number generator circuit further includes a true random number generator circuit configured to generate the seed for the pseudo random number generator circuit.

In some aspects, the techniques described herein relate to a memory device, wherein the number generator circuit further includes an input interface configured to receive the seed for the pseudo random number generator circuit.

In some aspects, the techniques described herein relate to a memory device, wherein the number generator circuit implements, at least in part, a pattern fill function to generate the sequence of numbers.

In some aspects, the techniques described herein relate to a method including: selecting, by a number generator circuit, a true random number generator circuit or a pseudo random number generator circuit as a random number source, generating, by the number generator circuit, a sequence of random numbers using the random number source, and outputting, by the number generator circuit, the sequence of random numbers.

In some aspects, the techniques described herein relate to a method, wherein outputting, by the number generator circuit, the sequence of random numbers includes outputting, by the number generator circuit, the sequence of random numbers to a processor configured to perform one or more compute operations using the sequence of random numbers.

In some aspects, the techniques described herein relate to a method, wherein outputting, by the number generator circuit, the sequence of random numbers includes outputting, by the number generator circuit, the sequence of random numbers to a direct memory access component configured to store the sequence of random numbers on an external device or to a memory device configured to store the sequence of random numbers.

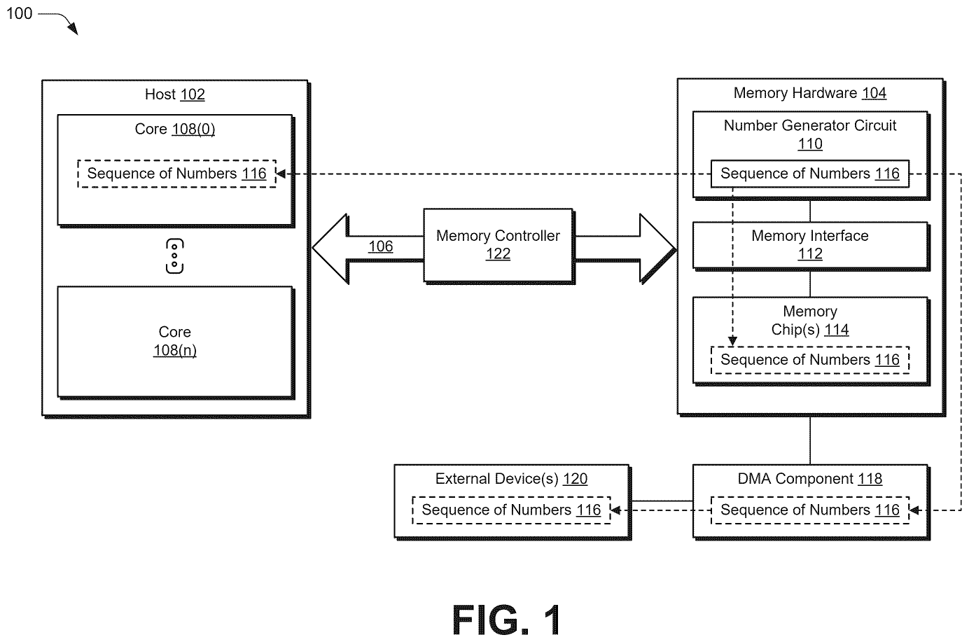

FIG. 1 depicts a non-limiting example system 100. The illustrated system 100 includes a host 102 and a memory hardware 104, where the host 102 and the memory hardware 104 are communicatively coupled via a connection/interface 106. In one or more implementations, the host 102 includes at least one core 108. In some implementations, the host 102 includes multiple cores 108. For instance, in the illustrated example, the host 102 is depicted as including core 108(0) and core 108(n), where n represents any integer.

The system 100 is implemented on one or more dies manufactured from a semiconductor material such as silicon, although other semiconductor material or composites thereof are contemplated. In an example implementation, the host 102 and the memory hardware 104 share a single die, such as in a system-on-chip configuration. In another example implementation, the host 102 is implemented on one die and the memory hardware 104 is implemented on another die. In either implementation, the connection/interface 106 is configured to facilitate communication between the host 102 and the memory hardware 104.

In accordance with the described techniques, the host 102 and the memory hardware 104 are coupled to one another via a wired or wireless connection, which is depicted in the illustrated example of FIG. 1 as the connection/interface 106. Example wired connections include, but are not limited to, buses (e.g., a data bus), interconnects, traces, planes, and optical fibers. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host 102 is an electronic circuit that includes one or more cores 108 that perform various operations on and/or using data. Examples of the host 102 include, but are not limited to, a central processing unit (CPU), a graphics processing unit (GPU), a field programmable gate array (FPGA), an accelerated processing unit (APU), and a digital signal processor (DSP). For example, in one or more implementations, a core 108 is a processing unit that reads and executes instructions (e.g., of a program), examples of which include to add, move, branch, or otherwise process data.

Examples of the memory hardware 104 include, but are not limited to, a single in-line memory module (SIMM), a dual in-line memory module (DIMM), small outline DIMM (SODIMM), microDIMM, load-reduced DIMM, registered DIMM (R-DIMM), non-volatile DIMM (NVDIMM), high bandwidth memory (HBM), and the like. In one or more implementations, the memory hardware 104 is a single integrated circuit device that incorporates a number generator circuit 110, a memory interface 112, and one or more memory chips 114 on a single semiconductor device. In some examples, the memory hardware 104 is composed of multiple chips that implement the number generator circuit 110, the memory interface 112, and the memory chip(s) 114, as vertical (“3D”) stacks, placed side-by-side on an interposer or substrate, or assembled via a combination of vertical stacking and side-by-side placement.

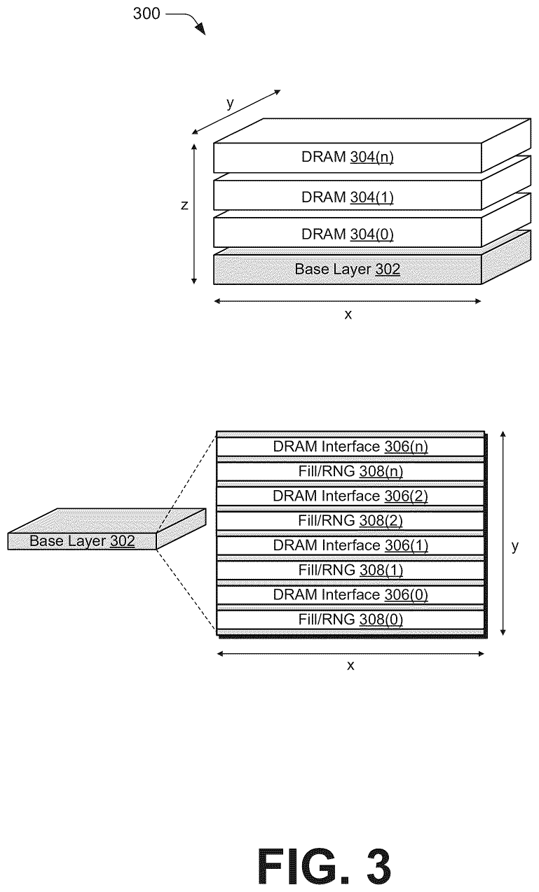

The number generator circuit 110 is configured to be tightly integrated with the memory interface 112, which enables efficient and fast communication between the number generator circuit 110 and the memory chip(s) 114. In one or more implementations, the memory interface 112 and the number generator circuit 110 are interleaved in a 3D stacked package for improved performance and power efficiency. For example, the number generator circuit 110 and the memory interface 112 are interleaved within a base layer of the 3D stacked package and one or more memory layers that include the memory chip(s) 114 are stacked on top of the base layer. Example configurations of the memory hardware 104 are illustrated and described below with reference to FIG. 3.

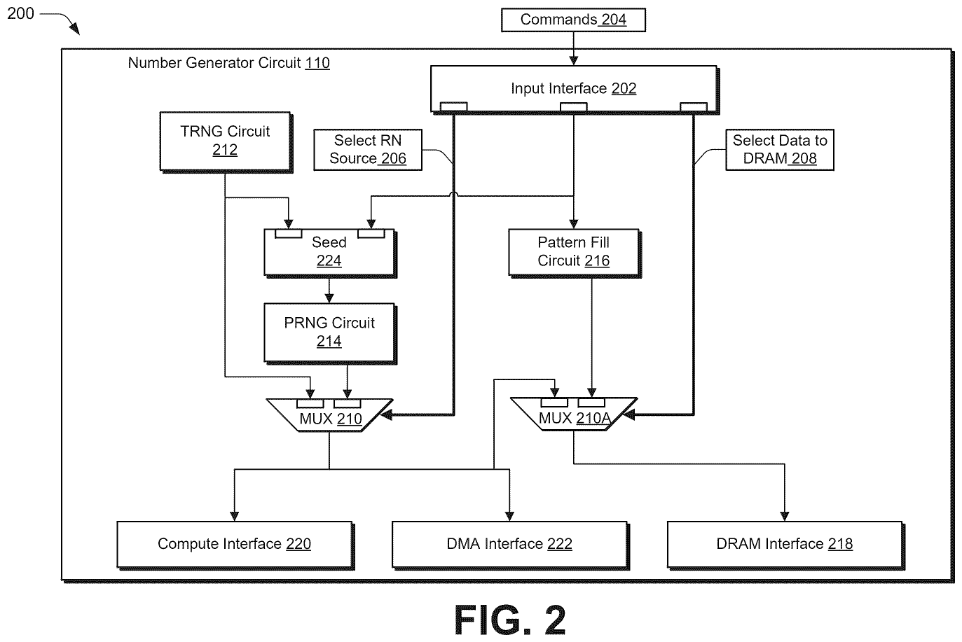

The number generator circuit 110 may include one or more of a true random number generator circuit or a pseudo random number generator circuit. In one or more implementations, the number generator circuit 110 includes a pseudo random number generator circuit that is implemented as a deterministic random bit generator circuit. In some cases, the number generator circuit 110 includes both a true random number generator circuit and a pseudo random number generator circuit. The random number generator circuit is a hardware unit that combines random number generation methods, encompassing both True Random Number Generation (TRNG) and Pseudo/Deterministic Random Number Generation (PRNG), with efficient pattern-based number generator via implementation of a pattern fill function, such as memset. This flexibility allows the system 100 to handle applications requiring high levels of security and unpredictability, as well as those requiring deterministic outputs for simulations and testing. Additionally, the pattern fill function enables efficient manipulation and initialization of memory blocks. This feature is integral for tasks that benefit from quick and reliable setting or resetting of memory values. An example number generator circuit 110 and components thereof are illustrated and described in greater detail below with reference to FIG. 2.

The number generator circuit 110 is configured to generate a sequence of numbers 116. The sequence of numbers 116, in one or more implementations, is a sequence of random numbers generated by via TRNG or PRNG methods performed by the number generator circuit 110. In some implementations, the PRNG method is pre-seeded from output of the TRNG method or statically based on input to the number generator circuit 110. In alternative implementations, the sequence of numbers 116 is generated based on a pattern. The number generator circuit 110 is configured to generate multiple sequences of numbers 116 using a single methodology or multiple methodologies, including, in some implementations, simultaneous performance of multiple methodologies to generate the sequences of numbers 116.

In different implementations, the TRNG functionality of the number generator circuit 110 uses any suitable form of physical entropy (with conditioning, as appropriate) for random number generation. A specific example implementation of the TRNG functionality in the number generator circuit 110 is analogous to how TRNG functionality is configured as part of crypto-coprocessor hardware. DRAM-based random number generation techniques, such as via violation of row activation time requirements, are particularly suitable for TRNG functionality implementations in the number generator circuit 110. Likewise, PRNG functionality of the number generator circuit 110 uses any of a variety of algorithms, or is configurable to support multiple algorithms. In some implementations, additional functionality is included in the number generator circuit 110 to support random number generation according to different statistical distributions.

The number generator circuit 110 is configured to output the sequence of numbers 116 to one or more components of the system 100 for storage, compute, or both. The sequence of numbers 116 is fixed length, variable length, or a stream with no defined length. In the illustrated example, the number generator circuit 110 outputs the sequence of numbers 116 to the memory chip(s) 114 for storage. The host 102 access the sequence of numbers 116 from the memory chip(s) 114 as needed. The number generator circuit 110 alternatively provides the sequence of numbers 116 directly to the host 102 for processing by the one or more cores 108. In some implementations, the number generator circuit 110 also outputs the sequence of numbers 116 to a direct memory access (DMA) component 118, such as a DMA controller configured to enable one or more external devices 120 to access the memory hardware 104 independently of the host 102. In one or more implementations, the DMA component 118 provides a mechanism through which the sequence of numbers 116 is obtained or otherwise received from the memory hardware 104 (e.g., from the memory chip(s) 114) and saved to a secondary location, such as the external device(s) 120. In an alternative implementation, a secondary buffer is maintained in memory, such as in the memory chip(s) 114 or in a fixed component (e.g., a dedicated static RAM), that is periodically flushed to the external device(s) 120 during memory idle periods. In other implementations, the DMA component 118 is extended to provide efficient read of the sequence of numbers 116 (e.g., as a stream of numbers) from the external device(s) 120, e.g., to reload previously saved random numbers when reproducing a scientific simulation.

The memory interface 112 includes the set of electrical and logical components that govern how the number generator circuit 110 and the memory chip(s) 114 communicate. As mentioned above, in one or more implementations, the memory interface 112 is interleaved with the number generator circuit 110 within a base layer of the memory hardware 104. In addition, the memory interface 112 enables the memory hardware 104 to connect to a memory controller 122 to enable communication with the host 102.

The memory controller 122 is configured to receive requests from the host 102 (e.g., from a core 108 of the host 102). Although depicted in the example system 100 as being implemented separately from the host 102, in some implementations, the memory controller 122 is implemented locally as part of the host 102. The memory controller 122 is further configured to schedule requests for a plurality of hosts 102, despite being depicted in the illustrated example of FIG. 1 as serving a single host 102. For instance, in an example implementation, the memory controller 122 schedules requests for a plurality of different hosts 102, where each of the plurality of different hosts 102 include one or more cores 108 that submit requests to the memory controller 122 for scheduling with the memory hardware 104.

In accordance with one or more implementations, the memory controller 122 is associated with a single channel of the memory hardware 104. For instance, the system 100 is configured to include a plurality of different memory controllers 122, one for each of a plurality of channels of the memory hardware 104. The techniques described herein are thus performable using a plurality of different memory controllers 122 to schedule requests for different channels of the memory hardware 104. In some implementations, a single channel in the memory hardware 104 is allocated into multiple pseudo-channels. In such implementations, the memory controller 122 is configured to schedule requests among different pseudo-channels of a single channel in the memory hardware 104.

The memory chip(s) 114 are used to store information, such as the sequence of numbers 116, for immediate use in a device (e.g., by a core 108 of the host). In one or more implementations, the memory chip(s) 114 correspond to semiconductor memory where the data is stored within memory cells on one or more integrated circuits. In at least one example, the memory chip(s) 114 correspond to or includes volatile memory, examples of which include random-access memory (RAM), dynamic random-access memory (DRAM), synchronous dynamic random-access memory (SDRAM) (e.g., single data rate (SDR) SDRAM or double data rate (DDR) SDRAM), ferroelectric RAM (FeRAM), resistive RAM (RRAM), a spin-transfer torque magnetic RAM (STT-MRAM), and static random-access memory (SRAM).

FIG. 2 depicts a non-limiting example configuration 200 of the number generator circuit 110. The example configuration 200 includes an input interface 202 configured to receive commands 204. In one or more implementations, the commands 204 originate from an application executed by the host 102. For example, the application is or includes a high performance computing, machine learning, or artificial intelligence application, although the application is not limited to any specific application type. The application generates the commands 204 autonomously, such as a result of being executed by the host 102. Additionally, or alternatively, the application generates the commands 204 responsive to specific requests, such as from another application and/or based on user input.

The illustrated example depicts two sample commands—a select random number source command 206 and a select data to DRAM command 208. The select random number source command 206 is provided as an input to a multiplexer (MUX) 210 that is configured to select either a TRNG circuit 212 or a PRNG circuit 214 as the random number source for generating the sequence of numbers 116. The select data to DRAM command 208 is provided as input to another MUX 210A that is configured to select between an output of the MUX 210 and an output of a pattern fill circuit 216 to be sent to DRAM (e.g., one or more of the memory chips 114) via a DRAM interface 218 for storage until accessed by the host 102.

The output of the MUX 210 includes the sequence of numbers 116 (i.e., random numbers) generated by the TRNG circuit 212 or the PRNG circuit 214. The MUX 210 outputs the sequence of numbers 116 to a compute interface 220, a DMA interface 222, the MUX 210A, or a combination thereof depending on specific implementation considerations. The compute interface 220 connects the number generator circuit 110 to compute hardware, such as the host 102 (or particularly one or more of the cores 108) and/or other compute hardware (e.g., processing-in-memory hardware), which receives the sequence of numbers 116 generated by the TRNG circuit 212 or the PRNG circuit 214 selected, based on the select random number source command 206, and processes the sequence of numbers 116 to perform one or more operations (e.g., via execution of an application). The DMA interface 222 connects the number generator circuit 110 to the DMA component 118, which receives the sequence of numbers 116 generated by the TRNG circuit 212 or the PRNG circuit 214 selected, based on the select random number source command 206, and stores the sequence of numbers 116 at the external device 120 (e.g., as a backup of the sequence of numbers 116 stored in the memory chip(s) 114).

In some implementations, the commands 204 also include input to the PRNG circuit 214 as a seed 224. Alternatively, in other implementations, output of the TRNG circuit 212 is provided to the PRNG circuit 214 as the seed 224. The seed 224 provides a starting point from which the sequence of numbers 116 is generated by the PRNG circuit 214. This initial value is used to initialize the state of the PRNG circuit 214, and it determines the subsequent sequence of random numbers produced by the PRNG circuit 214. The nature of PRNGs is such that, if the same seed 224 is used, the output of the PRNG circuit 214 will be the same sequence of numbers 116 each time. The output of the TRNG circuit 212 as the seed 224 ensures the randomness and unpredictably of the output from the PRNG circuit 214. The seed 224 itself is a number, but for applications requiring high levels of randomness, such as cryptography, the seed 224, in some implementations, is sourced from a highly variable source, like system time or user input (e.g., via the input interface 202), to generate the seed 224. This ensures that the sequence of numbers 116 is as unpredictable as possible.

FIG. 3 depicts multiple views of an example memory device 300 configured the same as or similar to the memory hardware 104 depicted in FIG. 1. A 3D memory stack view of the memory device 300 is shown having a base layer 302 on which multiple DRAM chips 304(0)-304(n) (e.g., the memory chip(s) 114) are stacked. Although the DRAM chips 304(0)-304(n) are shown in the illustrated example, other types of memory chips 114 are contemplated, including, for example, HBM, another type of DRAM, NVM, SRAM, combination thereof, and/or the like. The base layer 302 is depicted as including interleaved portions of a DRAM interface 306(0)-306(n) (e.g., the DRAM interface 218 introduced in FIG. 2) and fill/RNG components 308(0)-308(n) (e.g., the number generator circuit 110 introduced in FIG. 1 and described in greater detail in FIG. 2).

In various implementations, the DRAM interface 306 and the fill/RNG components 308 are distributed differently across a base die. As such, the illustrated example is merely exemplary and should not be construed as being limiting in any way. In some implementations, the memory device 300 plus the base layer 302 is integrated with a system-on-chip in 2.5D or in 3D (e.g., by stacking directly above or below compute hardware). In other implementations, the DRAM interface 306 and the fill/RNG components 308 are directly integrated into a system-on-chip base die, without a separate physical die including the base layer 302. Instead, the memory device 300 is stacked directly on top of the component containing the DRAM interface 306 and the fill/RNG components 308. In another implementation, the fill/RNG components 308 are co-loaded with a buffer or interface logic in memory DIMMs. Different proportions and bandwidths of devices and components thereof are supported according to process node, area, power, and performance requirements and capabilities.

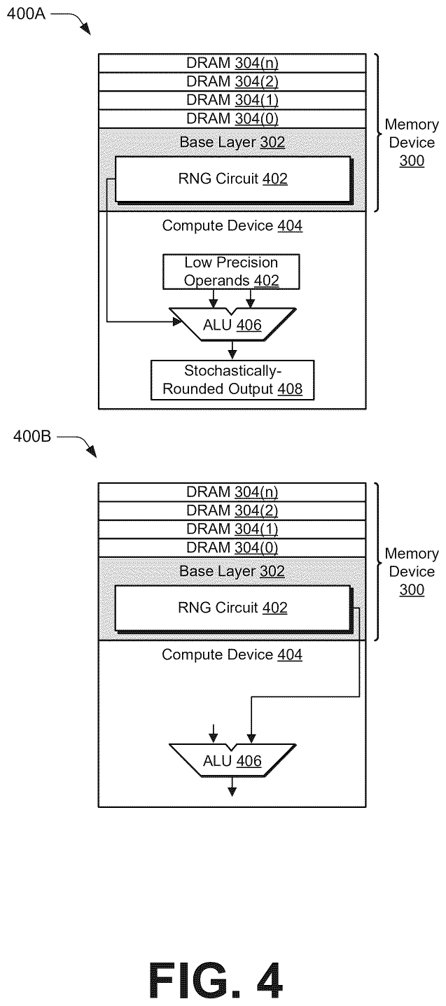

FIG. 4 depicts example implementations of a system 400 configured to supply random numbers to an arithmetic logic unit (ALU) for stochastic applications. The illustrated system 400 includes the memory device 300 introduced in FIG. 3. Here, the memory device 300 includes multiple memory layers shown as DRAM 304(0)-304(n) stacked on top of a base layer 302 that includes an RNG circuit 402, such as the TRNG circuit 212 and/or the PRNG circuit 214, described above with reference to FIG. 2.

In some implementations, such as shown in the system 400A, the RNG circuit 402 is configured to directly supply random values at a high rate and low latency to a compute device 404 (e.g., a 3D-stacked compute die hybrid-bonded to the memory stack), without prior storage to DRAM, to save power and improve performance. For instance, it is useful for the RNG circuit 402 to directly feed random values to the compute device 404 to enable its ALU 406 to perform stochastic rounding more efficiently to produce a stochastically rounded output 408

Other stochastic applications, such as Monte Carlo simulations, also benefit from such an approach, using the RNG directly as an ALU operand depicted in the system 400B. In some implementations, the compute device 404 maintains a buffer of random bits from the dedicated RNG circuit 402. In other implementations, the RNG circuit 402 is directly connected to the ALU(s) 406, e.g., by hybrid-bonded connections directly from the output of the RNG circuit 402 to the ALU(s) 406 in the compute device 404. In some implementations, such as with 3D-stacked compute and memory, the RNG circuit 402 functions in the base layer 302 and the ALU(s) 406 function in the compute device 404 stacked directly above/below one another, to minimize X/Y routing distance and maximize performance/power efficiency.

In some implementations, one or more ALUs 406 are directly integrated with the RNG circuit 402, such as depicted in FIG. 2 with the TRNG circuit 212 and the PRNG circuit 214 directly integrated with the ALU 406. This tight integration enables efficient stochastic rounding for artificial intelligence/machine learning data pre-processing within the memory device 300 without interfering with other CPU or GPU compute operations, such as performed by one or more of the cores 108 of the host 102.

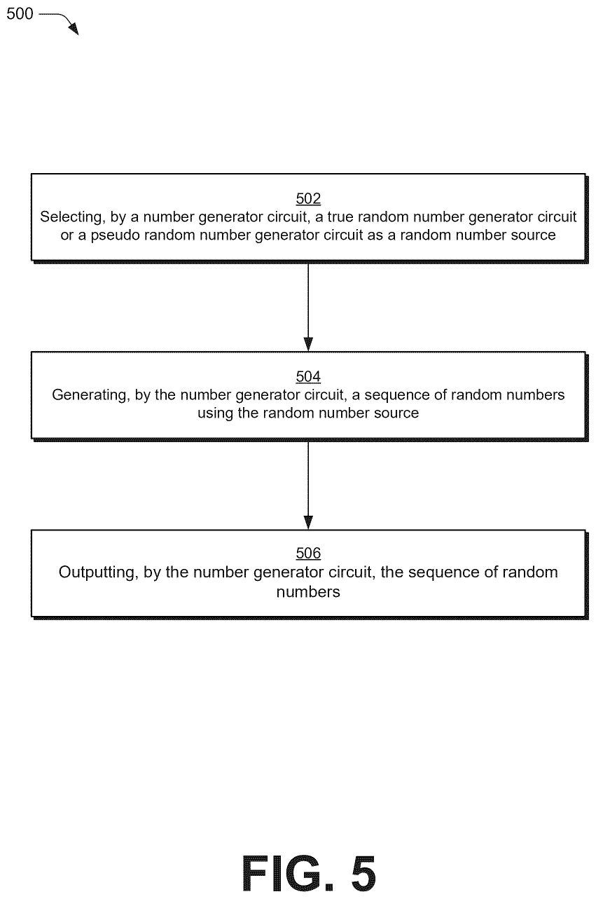

FIG. 5 depicts an example method 500 for generating a sequence of random numbers. The method 500 will be described from the perspective of a number generator circuit, such as the number generator circuit 110 and components thereof introduced above with respect to FIG. 2.

The number generator circuit 110 selects the TRNG circuit 212 or the PRNG circuit 214 as a random number source (step 502). In some implementations, this selection is made based on the select random number source command 206 received via the input interface 202. In other implementations, such as the number generator circuit implemented as either a TRNG circuit 212 or a PRNG circuit 214, the step 502 is not used. Otherwise, the step 502 is implemented as an optional step of the method 500.

Responsive to the selection made at step 502, the number generator circuit 110 generates the sequence of numbers 116 using the selected random number source (step 504). In some implementations, the PRNG method is pre-seeded from output of the TRNG method or statically based on input to the number generator circuit 110. The number generator circuit 110 is configured to generate multiple sequences of numbers 116 using a single methodology or multiple methodologies, including, in some implementations, simultaneous performance of multiple methodologies to generate the sequences of numbers 116. As such, the method 500, in some implementations, loops back to step 502 for each sequence of numbers 116 to be generated. Alternatively, batches of fixed length or variable length sequences of numbers 116 are generated. A stream of the sequence of numbers 116 is also contemplated.

In different implementations, the TRNG functionality of the number generator circuit 110 uses any suitable form of physical entropy (with conditioning, as appropriate) for random number generation. A specific example implementation of the TRNG functionality in the number generator circuit 110 is analogous to how TRNG functionality is configured as part of crypto-coprocessor hardware. DRAM-based random number generation techniques, such as via violation of row activation time requirements, are particularly suitable for TRNG functionality implementations in the number generator circuit 110. Likewise, PRNG functionality of the number generator circuit 110 uses any of a variety of algorithms, or is configurable to support multiple algorithms. In some implementations, additional functionality is included in the number generator circuit 110 to support random number generation according to different statistical distributions.

The number generator circuit 110 then outputs the sequence of numbers 116 (step 506). This output occurs after the sequence of numbers 116 is generated. For a stream of the sequence of numbers 116, the step 506 is performed simultaneously as random numbers are generated such that the number generator circuit 110 outputs the sequence of numbers 116 in a first-in-first-out fashion.

The number generator circuit 110 is configured to output the sequence of numbers 116 to one or more components of the system 100 for storage, compute, or both. The sequence of numbers 116 is fixed length, variable length, or a stream with no defined length. In the illustrated example, the number generator circuit 110 outputs the sequence of numbers 116 to the memory chip(s) 114 for storage. The host 102 access the sequence of numbers 116 from the memory chip(s) 114 as needed. The number generator circuit 110 alternatively provides the sequence of numbers 116 directly to the host 102 for processing by the one or more cores 108. In some implementations, the number generator circuit 110 also outputs the sequence of numbers 116 to the DMA component 118, such as a DMA controller configured to enable one or more external devices 120 to access the memory hardware 104 independently of the host 102. In one or more implementations, the DMA component 118 provides a mechanism through which the sequence of numbers 116 is obtained or otherwise received from the memory hardware 104 (e.g., from the memory chip(s) 114) and saved to a secondary location, such as the external device(s) 120. In an alternative implementation, a secondary buffer is maintained in memory, such as in the memory chip(s) 114 or in a fixed component (e.g., a dedicated static RAM), that is periodically flushed to the external device(s) 120 during memory idle periods. In other implementations, the DMA component 118 is extended to provide efficient read of the sequence of numbers 116 (e.g., as a stream of numbers) from the external device(s) 120, e.g., to reload previously saved random numbers when reproducing a scientific simulation.

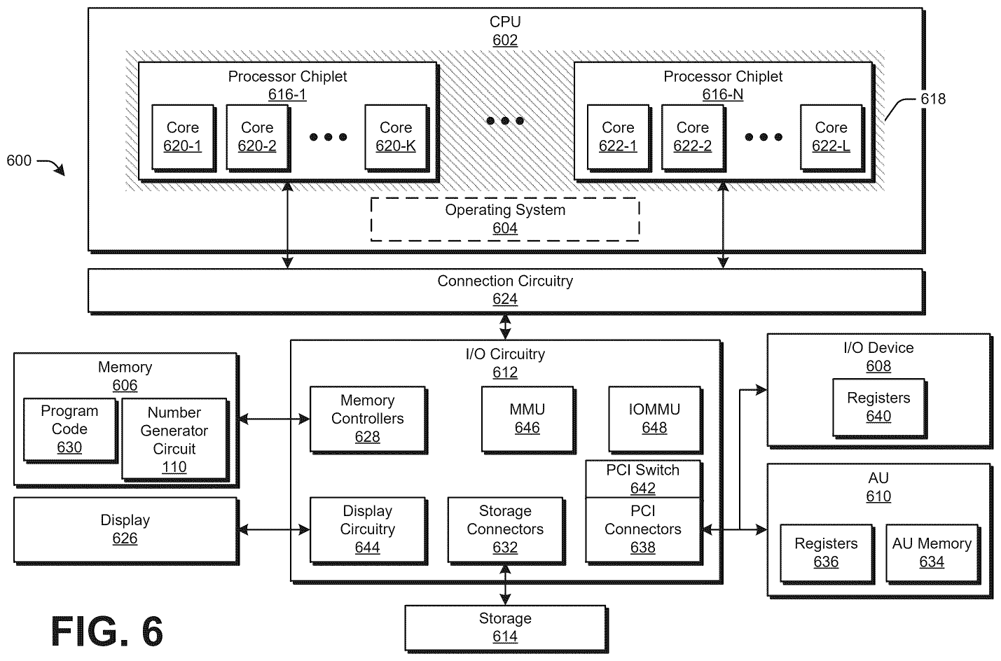

FIG. 6 is a block diagram of a processing system configured to execute one or more applications, in accordance with one or more implementations.

FIG. 6 includes a processing system 600 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 600 includes a central processing unit (CPU) 602. In one or more implementations, the CPU 602 is configured to run an operating system (OS) 604 that manages the execution of applications. For example, the OS 604 is configured to schedule the execution of tasks (e.g., instructions) for applications, allocate portions of resources (e.g., system memory 606, CPU 602, input/output (I/O) device 608, accelerator unit (AU) 610, storage 614) for the execution of tasks for the applications, provide an interface to I/O devices (e.g., I/O device 608) for the applications, or any combination thereof.

The CPU 602 includes one or more processor chiplets 616, which are communicatively coupled together by a data fabric 618 in one or more implementations.

Each of the processor chiplets 616, for example, includes one or more processor cores 620, 622 configured to concurrently execute one or more series of instructions, also referred to herein as “threads,” for an application. Further, the data fabric 618 communicatively couples each processor chiplet 616-N of the CPU 602 such that each processor core (e.g., processor cores 620) of a first processor chiplet (e.g., 616-1) is communicatively coupled to each processor core (e.g., processor cores 622) of one or more other processor chiplets 616. Though the example embodiment presented in FIG. 6 shows a first processor chiplet (616-1) having three processor cores (620-1, 620-2, 620-K) representing a K number of processor cores 622 and a second processor chiplet (616-N) having three processor cores (e.g., 622-1, 622-2, 622-L) representing an L number of processor cores 622, in other implementations (L being an integer number greater than or equal to one), each processor chiplet 616 may have any number of processor cores 620, 622. For example, each processor chiplet 616 can have the same number of processor cores 620, 622 as one or more other processor chiplets 616, a different number of processor cores 620, 622 as one or more other processor chiplets 616, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 600, the CPU 602 is communicatively coupled to an I/O circuitry 612 by a connection circuitry 624. For example, each processor chiplet 616 of the CPU 602 is communicatively coupled to the I/O circuitry 612 by the connection circuitry 624. The connection circuitry 624 includes, for example, one or more data fabrics, buses, buffers, queues, and the like. The I/O circuitry 612 is configured to facilitate communications between two or more components of the processing system 600 such as between the CPU 602, system memory 606, display 626, universal serial bus (USB) devices, peripheral component interconnect (PCI) devices (e.g., I/O device 608, AU 610), storage 614, and the like.

As an example, system memory 606 includes any combination of one or more volatile memories and/or one or more non-volatile memories, examples of which include dynamic random-access memory (DRAM), static random-access memory (SRAM), non-volatile RAM, and the like. To manage access to the system memory 606 by CPU 602, the I/O device 608, the AU 610, and/or any other components, the I/O circuitry 612 includes one or more memory controllers 628. These memory controllers 628, for example, include circuitry configured to manage and fulfill memory access requests issued from the CPU 602, the I/O device 608, the AU 610, or any combination thereof. Examples of such requests include read requests, write requests, fetch requests, pre-fetch requests, or any combination thereof. That is to say, these memory controllers 628 are configured to manage access to the data stored at one or more memory addresses within the system memory 606, such as by CPU 602, the I/O device 608, and/or the AU 610.

When an application is to be executed by processing system 600, the OS 604 running on the CPU 602 is configured to load at least a portion of program code 630 (e.g., an executable file) associated with the application from, for example, a storage 614 into system memory 606. This storage 614, for example, includes a non-volatile storage such as a flash memory, solid-state memory, hard disk, optical disc, or the like configured to store program code 630 for one or more applications.

In this example, the number generator circuit 110 is depicted in the memory 606 of the processing system 600. In variations, however, the number generator circuit 110 is included in and/or is implemented by one or more different components of the processing system 600, such as the CPU 602, the I/O device 608, the AU 610, the I/O circuitry 612, the storage 614, and so forth. In at least one implementation, the number generator circuit 110 or portions of the number generator circuit 110 is included in at least two of the depicted components of the processing system 600. By way of example, the number generator circuit 110 may be included in or otherwise implemented by at least the memory 606 and the CPU 602.

To facilitate communication between the storage 614 and other components of processing system 600, the I/O circuitry 612 includes one or more storage connectors 632 (e.g., universal serial bus (USB) connectors, serial AT attachment (SATA) connectors, PCI Express (PCIe) connectors) configured to communicatively couple storage 614 to the I/O circuitry 612 such that I/O circuitry 612 is capable of routing signals to and from the storage 614 to one or more other components of the processing system 600.

In association with executing an application, in one or more scenarios, the CPU 602 is configured to issue one or more instructions (e.g., threads) to be executed for an application to the AU 610. The AU 610 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 610 includes one or more compute units that concurrently execute one or more threads of an application and store data resulting from the execution of these threads in AU memory 634. This AU memory 634, for example, includes any combination of one or more volatile memories and/or non-volatile memories, examples of which include caches, video RAM (VRAM), or the like. In one or more implementations, these compute units are also configured to execute these threads based on the data stored in one or more physical registers 636 of the AU 610.

To facilitate communication between the AU 610 and one or more other components of processing system 600, the I/O circuitry 612 includes or is otherwise connected to one or more connectors, such as PCI connectors 638 (e.g., PCIe connectors) each including circuitry configured to communicatively couple the AU 610 to the I/O circuitry such that the I/O circuitry 612 is capable of routing signals to and from the AU 610 to one or more other components of the processing system 600. Further, the PCIe connectors 638 are configured to communicatively couple the I/O device 608 to the I/O circuitry 612 such that the I/O circuitry 612 is capable of routing signals to and from the I/O device 608 to one or more other components of the processing system 600.

By way of example and not limitation, the I/O device 608 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 608 is configured to execute one or more operations, tasks, instructions, or any combination thereof based on one or more physical registers 640 of the I/O device 608. In one or more implementations, such physical registers 640 are configured to maintain data (e.g., operands, instructions, values, variables) indicating one or more operations, tasks, or instructions to be performed by the I/O device 608.

To manage communication between components of the processing system 600 (e.g., AU 610, I/O device 608) that are connected to PCI connectors 638, and one or more other components of the processing system 600, the I/O circuitry 612 includes PCI switch 642. The PCI switch 642, for example, includes circuitry configured to route packets to and from the components of the processing system 600 connected to the PCI connectors 638 as well as to the other components of the processing system 600. As an example, based on address data indicated in a packet received from a first component (e.g., CPU 602), the PCI switch 642 routes the packet to a corresponding component (e.g., AU 610) connected to the PCI connectors 638.

Based on the processing system 600 executing a graphics application, for instance, the CPU 602, the AU 610, or both are configured to execute one or more instructions (e.g., draw calls) such that a scene including one or more graphics objects is rendered. After rendering such a scene, the processing system 600 stores the scene in the storage 614, displays the scene on the display 626, or both. The display 626, for example, includes a cathode-ray tube (CRT) display, liquid crystal display (LCD), light emitting diode (LED) display, organic light emitting diode (OLED) display, or any combination thereof. To enable the processing system 600 to display a scene on the display 626, the I/O circuitry 612 includes display circuitry 644. The display circuitry 644, for example, includes high-definition multimedia interface (HDMI) connectors, DisplayPort connectors, digital visual interface (DVI) connectors, USB connectors, and the like, each including circuitry configured to communicatively couple the display 626 to the I/O circuitry 612. Additionally or alternatively, the display circuitry 644 includes circuitry configured to manage the display of one or more scenes on the display 626 such as display controllers, buffers, memory, or any combination thereof.

Further, the CPU 602, the AU 610, or both are configured to concurrently run one or more virtual machines (VMs), which are each configured to execute one or more corresponding applications. To manage communications between such VMs and the underlying resources of the processing system 600, such as any one or more components of processing system 600, including the CPU 602, the I/O device 608, the AU 610, and the system memory 606, the I/O circuitry 612 includes memory management unit (MMU) 646 and input-output memory management unit (IOMMU) 648. The MMU 646 includes, for example, circuitry configured to manage memory requests, such as from the CPU 602 to the system memory 606. For example, the MMU 646 is configured to handle memory requests issued from the CPU 602 and associated with a VM running on the CPU 602. These memory requests, for example, request access to read, write, fetch, or pre-fetch data residing at one or more virtual addresses (e.g., guest virtual addresses) each indicating one or more portions (e.g., physical memory addresses) of the system memory 606. Based on receiving a memory request from the CPU 602, the MMU 646 is configured to translate the virtual address indicated in the memory request to a physical address in the system memory 606 and to fulfill the request. The IOMMU 648 includes, for example, circuitry configured to manage memory requests (memory-mapped I/O (MMIO) requests) from the CPU 602 to the I/O device 608, the AU 610, or both, and to manage memory requests (direct memory access (DMA) requests) from the I/O device 608 or the AU 610 to the system memory 606. For example, to access the registers 640 of the I/O device 608, the registers 636 of the AU 610, and/or the AU memory 634, the CPU 602 issues one or more MMIO requests. Such MMIO requests each request access to read, write, fetch, or pre-fetch data residing at one or more virtual addresses (e.g., guest virtual addresses) which each represent at least a portion of the registers 640 of the I/O device 608, the registers 636 of the AU 610, or the AU memory 634, respectively. As another example, to access the system memory 606 without using the CPU 602, the I/O device 608, the AU 610, or both are configured to issue one or more DMA requests. Such DMA requests each request access to read, write, fetch, or pre-fetch data residing at one or more virtual addresses (e.g., device virtual addresses) which each represent at least a portion of the system memory 606. Based on receiving an MMIO request or DMA request, the IOMMU 648 is configured to translate the virtual address indicated in the MMIO or DMA request to a physical address and fulfill the request.

In variations, the processing system 600 can include any combination of the components depicted and described. For example, in at least one variation, the processing system 600 does not include one or more of the components depicted and described in relation to FIG. 6. Additionally or alternatively, in at least one variation, the processing system 600 includes additional and/or different components from those depicted. The 600 is configurable in a variety of ways with different combinations of components in accordance with the described techniques.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host 102, the memory hardware 104, the interface 106, the core(s) 108, the number generator circuit 110, the memory interface 112, the memory chip(s) 114, the DMA component 118, the external device(s) 120, the memory controller 122, the input interface 202, the MUX(es) 210, 210A, the TRNG circuit 212, the PRNG circuit 214, the pattern fill circuit 216, the DRAM interface 218, the compute interface 220, the DMA interface 222, the ALU 406, or any combination thereof) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Array circuits (FPGAs), any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A system comprising:
a number generator circuit configured to generate a sequence of numbers;
a memory chip configured to store the sequence of numbers; and
a memory interface configured to enable communication between the number generator circuit and the memory chip.

2. The system of claim 1, further including a system-on-chip, and wherein the system-on-chip includes one or more processor cores, the number generator circuit, the memory chip, and the memory interface.

3. The system of claim 1, wherein the number generator circuit includes a random number generator circuit.

4. The system of claim 3, further including an arithmetic logic unit (ALU) configured to receive an operand from the random number generator circuit and to output the sequence of numbers.

5. The system of claim 4, wherein the random number generator circuit includes a true random number generator circuit, a pseudo random number generator circuit, or both the true random number generator circuit and the pseudo random number generator circuit.

6. The system of claim 5, wherein the true random number generator circuit is configured to output a seed, and the pseudo random number generator circuit is configured to receive the seed as input.

7. The system of claim 6, wherein the pseudo random number generator circuit is a deterministic random bit generator circuit.

8. The system of claim 1, wherein the number generator circuit implements, at least in part, a pattern fill function, and further including an arithmetic logic unit configured to receive an operand from the pattern fill function.

9. The system of claim 1, further including a three-dimensional package including a base layer, the base layer including the memory interface and the number generator circuit.

10. A memory device comprising:
a base layer;
a memory interface; and
a number generator circuit interleaved among the base layer and the memory interface and configured to generate a sequence of numbers.

11. The memory device of claim 10, further including one or more memory layers connected to the number generator circuit via the memory interface.

12. The memory device of claim 11, wherein the one or more memory layers are built directly on top of the base layer.

13. The memory device of claim 11, wherein the one or more memory layers are stacked vertically.

14. The memory device of claim 10, wherein the number generator circuit includes a pseudo random number generator circuit configured to generate the sequence of numbers based, at least in part, on a seed.

15. The memory device of claim 14, wherein the number generator circuit further includes a true random number generator circuit configured to generate the seed for the pseudo random number generator circuit.

16. The memory device of claim 14, wherein the number generator circuit further includes an input interface configured to receive the seed for the pseudo random number generator circuit.

17. The memory device of claim 14, wherein the number generator circuit implements, at least in part, a pattern fill function to generate the sequence of numbers.

18. A method comprising:
selecting, by a number generator circuit, a true random number generator circuit or a pseudo random number generator circuit as a random number source;
generating, by the number generator circuit, a sequence of random numbers using the random number source; and
outputting, by the number generator circuit, the sequence of random numbers.

19. The method of claim 18, wherein outputting, by the number generator circuit, the sequence of random numbers includes outputting, by the number generator circuit, the sequence of random numbers to a processor configured to perform one or more compute operations using the sequence of random numbers.

20. The method of claim 18, wherein outputting, by the number generator circuit, the sequence of random numbers includes outputting, by the number generator circuit, the sequence of random numbers to a direct memory access component configured to store the sequence of random numbers on an external device or to a memory device configured to store the sequence of random numbers.
